(19) United States
(12) Patent Application Publication
(10) Pub. No.: US 2005/0040607 A1
(43) Pub. Date: Feb. 24, 2005

(54) Annular seal, especially for a ball valve

(76) Inventor: Aloys Wobben, Aurich (DE)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/488,024

(22) PCT Filed: Aug. 27, 2002
(86) PCT No.: PCT/EP02/09531

(30) Foreign Application Priority Data
Aug. 28, 2001 (DE) 10141927.9

(51) Int. Cl. F16J 15/10

(52) U.S. Cl. 277/650

(57) ABSTRACT

In accordance with the invention a sealing ring of deformable material having a radially inwardly facing inner sealing surface and a radially outwardly facing outer sealing surface, characterized by at least one pressure surface which as a wall of a cavity in the sealing ring is in substantially radially opposite relationship to at least one of the sealing surfaces so that a fluid under pressure which bears in the cavity against the pressure surface urges the at least one sealing surface outwardly; and a sealing system comprising a first component with a bore, a second component which is arranged in the bore, and the sealing ring for sealing the gap between the first and the second component in relation to a fluid which at least at times is under pressure.

### FIELD OF THE INVENTION

The present invention concerns a sealing ring of deformable material having a radially inwardly facing inner sealing surface and a radially outwardly facing outer sealing surface as well as a sealing system comprising a first component with a bore, a second component which is arranged in the bore, and a sealing ring of the specified kind.

### BACKGROUND OF THE INVENTION

Seals for sealing off annular gaps are required in technology, in particular in mechanical engineering, in the most widely varying geometrical forms and forms of use. Consequently a wide range of different design configurations of such seals—also in the form of pre-prepared standard components, even standardized—are known in the state of the art. One of the simplest forms of known annular seals is an O-ring of rubber. A so-called shaft sealing ring for example is of a substantially more complicated configuration, being a sealing element comprising a metal ring as an outer seat and a radially inwardly facing sealing lip of rubber.

Shaft sealing rings of that kind serve for example for sealing a transmission casing, out of which a rotating shaft is passed. For that purpose the metal ring is seated in a bore in the casing, through which the shaft is passed, and the sealing lip bears against a circular-cylindrical peripheral surface of the shaft, that surface being as smooth as possible. The contact surface between the sealing lip and the surface of the shaft is reduced to an annular line around the shaft—more specifically by virtue of the fact that the sealing lip tapers radially inwardly to form a geometrically sharp edge. That configuration permits high speeds of rotation of the shaft, in which case for example transmission oil which is disposed in the interior of the casing and which is to be prevented from escaping from the casing by the seal forms a lubricating film under the sealing lip. As is known in that situation dynamic pressure conditions in the region of the contact surface provide that the oil does not penetrate outwardly by passing through beneath the sealing lip.

A further problem in regard to the configuration of the above-described seals arises out of the fact that the fluid, in relation to which the gap between the two components is to be sealed, is usually under an increased pressure or a reduced pressure and, as a consequence of those pressure conditions, a force is exerted on at least one of the components. To carry that force, it is known to arrange additional plain bearings between the first and the second components. Those plain bearings carry the forces exerted by the fluid pressure and provide for greater ease of mobility as between the two components than if the materials from which the two components are made were to rub directly against each other.

For structural reasons the plain bearings are usually disposed in the immediate proximity of the seal. As the plain bearings are frequently exposed to wear by virtue of the relative movement of the two components with respect to each other, after a certain operating period direct contact can nonetheless occur between the two components, whereby the relative movement of the two components with respect to each other is made more difficult.

There is also the disadvantage that wear particles from the plain bearing can pass into the region of the seal. That results in increased wear of the seal and thus regularly causes a deterioration in the sealing action. In addition, even without the seal suffering from wear, deformation of the seal can occur due to migration of wear particles through the sealing gap, and as a consequence a leak can occur.

In addition in particular felt rings are known for sealing annular gaps around a component which not only rotates but which is also moved with a translatory motion through the bore.

The effect of known sealing rings is often not sufficient, in particular in relation to fluids which are under pressure, so that unwanted leakage can occur.

### SUMMARY OF THE INVENTION

One object of the invention is to provide a seal and a sealing system, the sealing effect of which is improved over the current systems.

According to the invention that object is attained by a seal having the features of claim 1.

For the purposes of sealing an annular gap between two components a sealing ring of deformable, preferably elastically deformable material, for example a polymer, has two sealing surfaces of which faces radially inwardly and one faces radially outwardly. Those sealing surfaces then usually bear against complementary sealing surfaces, for example in a sealing groove which is provided suitably in the region of the gap. In accordance with the invention the sealing ring is characterized by at least one pressure surface which is in the form of a wall of a cavity in the sealing ring. The at least one pressure surface is disposed in substantially radially opposite relationship to at least one of the sealing surfaces so that a fluid which occurs in the cavity under pressure against the pressure surface urges the at least one sealing surface outwardly and therefore, upon appropriate installation, against a complementary sealing surface of a component. The sealing effect is substantially improved by that pressure, which is increased in accordance with the invention, of a sealing surface of the sealing ring according to the invention. That is particularly advantageous in relation to annular gaps which are to be sealed off in relation to a fluid which is under pressure. In accordance with the invention, in such an installation situation for the sealing ring according to the invention, it is possible to make use of the pressure of the fluid insofar as the sealing ring according to the invention is so installed that a fluid opening which leads outwardly from the cavity allows the fluid to penetrate into the cavity and there exerts its pressure on the pressure surface and thereby on the radially oppositely disposed sealing surface.

Preferably the cavity is provided in the sealing ring, in the form of a groove in an axial outside surface of the sealing ring on the periphery of the sealing ring. Then, particularly when the sealing ring is in the shape of a circular cylindrical tube, the radial boundary surfaces of the groove are in opposite relationship to the two sealing surfaces of the ring (one facing outwardly and one facing inwardly) and when a pressure is applied to the groove by a fluid under pressure, the boundary surfaces urge the sealing surfaces from the cross-section of the sealing ring outwardly, that is to say radially outwardly or radially inwardly.

The sealing system according to the invention includes a first component having a bore, a second component arranged in the bore and a sealing ring for sealing the gap between the first and second components in relation to a fluid which at least at times is under pressure. Further provided between the first and second components is a rolling bearing for carrying axial forces between the two components, which act on the second component.

In that case the rolling bearing can be disposed on the sealed side in the region of the gap between the two components or it can be arranged on the non-sealed side of the gap. In the latter case the materials of the rolling bearing components are to be so selected as to be resistant in relation to the fluid.

The roiling bearing carries the forces which are carried by the plain bearing in the state of the art and can therefore substantially relieve the load on the plain bearing or even make it dispensable. The wear of the plain bearing is thereby greatly reduced or completely avoided. Even in a situation involving high loadings due to high forces and high relative speeds which occur over a long time between the two components, the rolling bearing itself is almost wear-free.

A particularly advantageous sealing system is one in which, on the pressure side of the seal, a plain bearing, in particular an axial-radial plain bearing, is combined with a rolling bearing on the sealed side. That provides for a particularly advantageous sealing effect and ensures that the forces between the two components are carried in an advantageous manner.

An advantageous development of the sealing system provides that a thrust groove-type ball bearing is selected as the rolling bearing.

The thrust groove-type ball bearing is particularly suitable for the usually cramped conditions as it is of a very compact form. In addition it is adapted to carry the forces which frequently occur predominantly in the longitudinal direction of the bore in the first component, that is to say the axial forces, between the first and second components.

A further advantageous embodiment of the sealing system according to the invention includes a first component having a bore, a second component which is arranged in the bore and a sealing ring of the above-described kind which seals off the gap between the two components in relation to a fluid which at least at times is under pressure.

In a particularly advantageous manner the sealing ring according to the invention can be combined with a rolling bearing, as described hereinbefore. That provides for particularly long-lived and reliable sealing of the gap between the first and second components.

Particularly in the case of sealing gaps which are in the form of a cylindrical surface, the sealing system according to the invention provides a simple and effective sealing action.

Particularly preferred is the use of the sealing ring and sealing system according to the invention for sealing the gap between an actuating spindle of a ball valve and the housing of a ball valve.

The pressure of the fluid on the inside surface of the flow passage formed in the ball exerts a force on the ball, which is transmitted to the actuating spindle fixed to the ball. In the case of the sealing system according to the invention, that force is advantageously transmitted to the housing of the ball valve from the actuating spindle by way of the rolling bearing. With the sealing system according to the invention therefore, plain bearings which are possibly present and the seal itself are not subjected to the effect of those forces or they are only slightly subjected thereto, and they are therefore substantially relieved of stress. Wear of the seal and the plain bearing therefore does not occur or scarcely occurs.

### BRIEF DESCRIPTION OF THE SEVERAL VIEWS OF THE DRAWING(S)

Preferred embodiments of the invention are described with reference to the accompanying drawings in which:

FIG. 1 is a partially sectional side view of an embodiment of the sealing system according to the invention,

FIG. 2 is a partly sectional front view of a second embodiment of the sealing system according to the invention, and

FIG. 3 is a partly sectional front view of a third embodiment of the sealing system according to the invention.

### DETAILED DESCRIPTION OF THE INVENTION

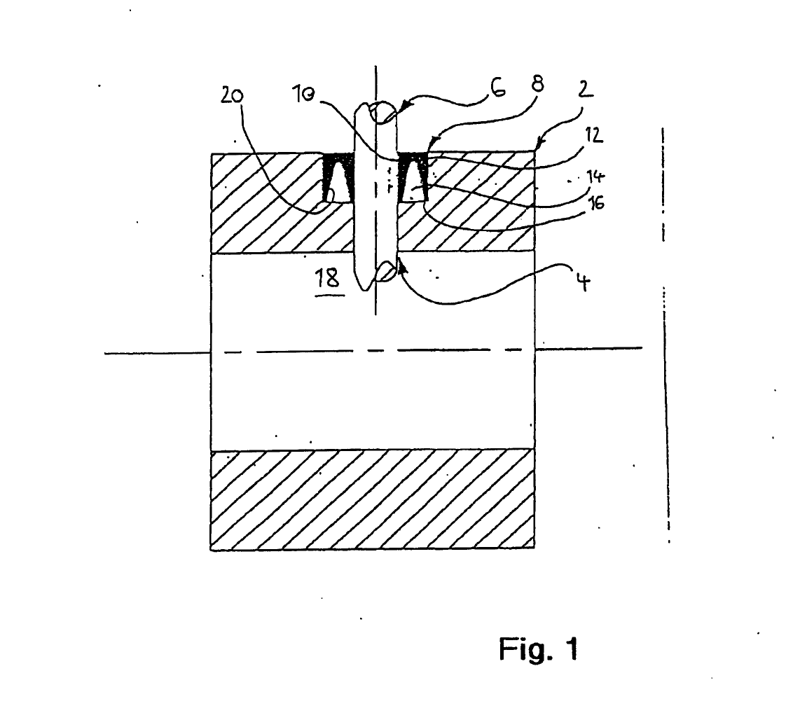

FIG. 1 shows a housing 2 having a bore 4 in which an actuating spindle of a ball valve (not shown) is arranged. The gap between the actuating spindle 6 and the housing 2 is sealed off by a sealing ring 8 with an outside contour in the shape of a circular cylindrical tube.

The sealing ring 8 has an inwardly facing inner sealing surface 10 and an outwardly facing outer sealing surface 12. The radially inwardly facing sealing surface 10 bears against a radially outwardly facing surface of the circular-cylindrical actuating spindle 6 and the radially outwardly facing sealing surface 12 bears against a radially inwardly facing surface 14 of a groove 16 in the housing 2, in which the sealing ring 8 is fitted.

A cavity 14 is provided in the sealing ring 8. The cavity is a groove in an axial outside surface 16 of the sealing ring 8. The groove 14 opens in the direction of a fluid 18 which is under pressure in the housing 2 and which penetrates through the gap 4 between the actuating spindle 6 and the wall of the bore 4 to the sealing ring 8 and there applies pressure to the cavity 14. The cavity 14 has a wall 20 which is of a parabolic configuration in cross-section. The wall 20, with respective ‘limbs’ of the parabola, lies in radially opposite relationship to respective ones of the sealing surfaces 10, 12 and, being acted upon by the pressure of the fluid 18, presses the sealing surfaces against the complementary sealing surfaces of the housing 2 and the actuating spindle 6.

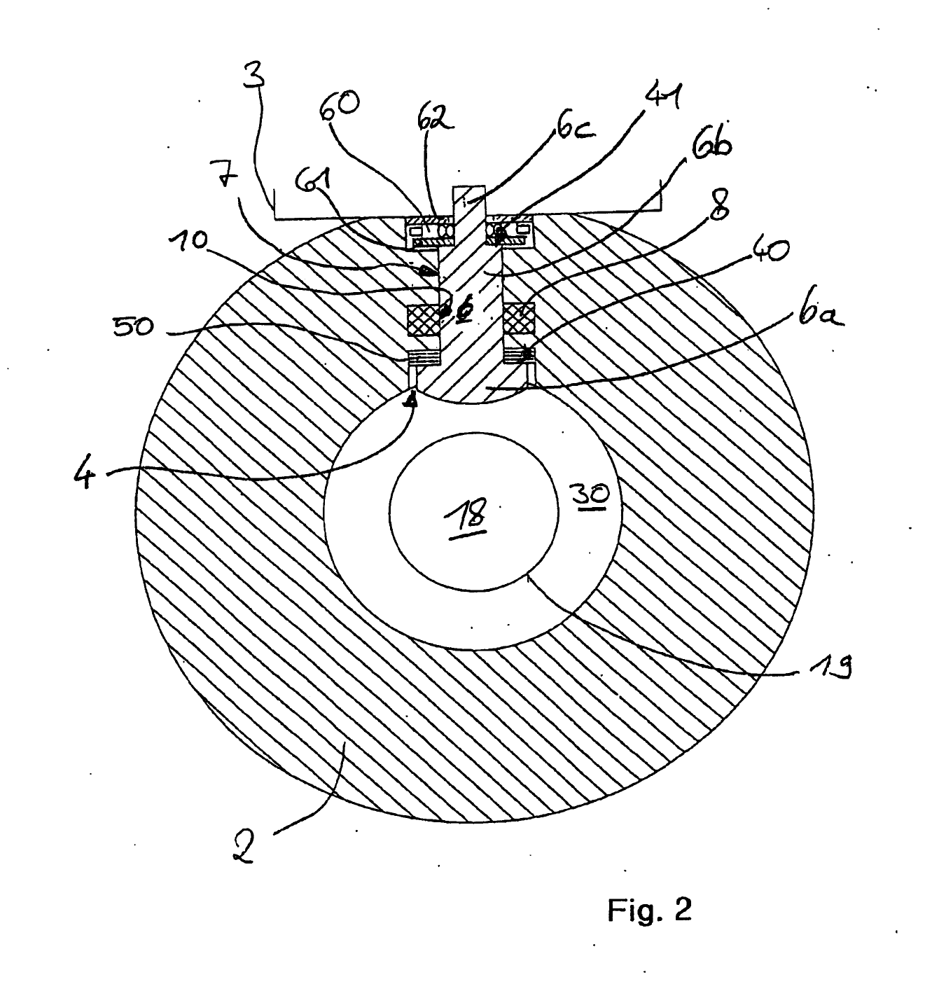

The actuating spindle 6 of the embodiment illustrated in FIG. 2 has a first portion 6a, a second portion 6b and a third portion 6c. The portion 6a is positively lockingly connected to the ball (not shown) of the ball valve, the ball being arranged in the cavity 30 in the housing 2. The portion 6b has a cylindrical surface 7, in relation to which the sealing surface 10 of the seal 8 seals.

Formed at the transition from the portion 6a to the portion 6b is a step having a surface 40 which is perpendicular to the longitudinal direction of the actuating spindle 6. Also provided at the transition from the portion 6b to the portion 6c is a step having a surface 41 which is parallel to the surface 40.

The surface 40 of the first step is in contact with an annular plain bearing 50 arranged in the bore 4. The plain bearing 50 is in the form of a thrust-radial plain bearing and is supported in the region of a step in the bore 4 against the cylindrical outside surface and the annular end face of that step in the bore 4. The thrust-radial plain bearing is adapted to carry axial forces which are directed radially outwardly in the flow passage 19 containing the fluid 18. For that purpose the surface 40 of the first step on the actuating spindle is remote from the flow passage 19 for the fluid 18 and the annular end face of the step of the bore 4 is towards the flow passage 19.

A first bearing shell 61 of a thrust groove-type ball bearing 60 is supported against the surface 41 of the second step on the actuating spindle 6. The surface 41 faces away from the flow passage 19.

A second bearing shell 62 of the thrust groove-type ball bearing is supported against a housing portion 3 of the housing 2.

The balls of the groove-type ball bearing 60 are arranged between the first and second bearing shells 61, 62.

The upper end portion of the portion 6c of the actuating spindle 6, like also in the case of the above-described embodiment, can be provided with shaped surfaces such as for example square surfaces in order to apply a torque about the longitudinal axis of the actuating spindle 6 to the actuating spindle.

The spacings of the surfaces 40 and 41 of the actuating spindle and the annular support surface in the step of the bore 4 and the support surface on the housing portion 3 which supports the second bearing shell 62 are so selected that axially outwardly directed forces are passed from the actuating spindle 6 into the housing portion 3 by way of the groove-type ball bearing 60 and transmission of those forces by way of the plain bearing 50 is substantially or completely avoided. In other words, the thrust groove-type ball bearing 60 and the plain bearing 50 do not represent an overdefined bearing arrangement as the plain bearing 50 has axial clearance.

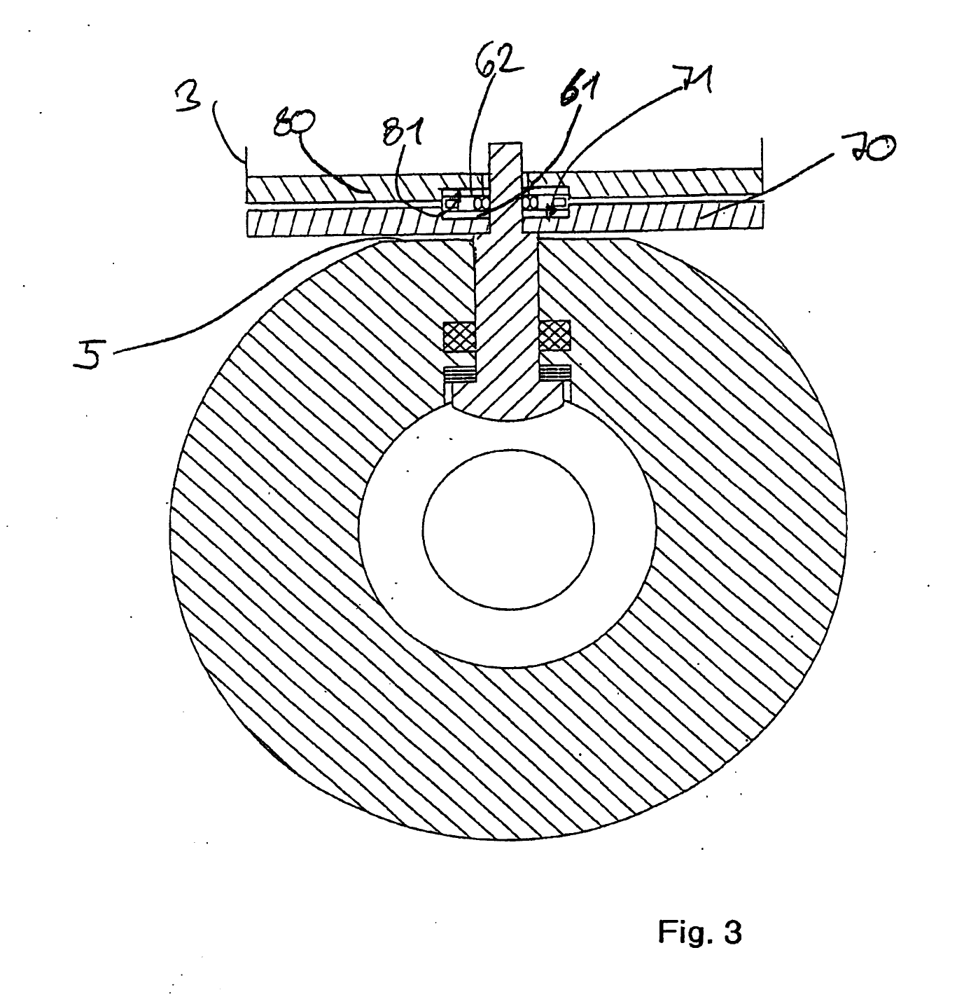

The embodiment shown in FIG. 3 is identical to that shown in FIG. 2, in regard to the portions 6a, 6b of the actuating spindle 6, the plain bearing 50 and the seal 8.

The housing 2 of the embodiment in FIG. 3 has a flattened portion 5 at the end of the bore 4, which is remote from the flow passage 19. The flattened portion 5 is perpendicular to the longitudinal axis of the bore 4.

The annular surface 41 of the second step on the actuating spindle 6 projects beyond the flattened portion 5 of the housing 2. Arranged on the surface 41 is a plate 70 having an annular recess 71. The first bearing shell 61 is arranged in the annular recess 71.

The groove-type ball bearing 60 projects axially beyond the annular recess 71. The second bearing shell 62 of the groove-type ball bearing 60 is arranged and supported in an annular recess 81 in a second plate 80. The second plate 80 is connected to a housing portion 3.

In the embodiment in FIG. 3 the torque required for actuation of the actuating spindle 6 can be applied in the same manner as in the above-discussed embodiments by way of shaped surfaces provided in the end region of the portion 6c. Alternatively the torque required for actuation can be applied by way of the plate 70 if it is connected to the actuating spindle 6 fixedly in respect of the transmission of torque.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A sealing ring for a ball valve of elastically deformable material having a radially inwardly facing inner sealing surface and a radially outwardly facing outer sealing surface, characterized by at least one pressure surface which as a wall of a cavity in the sealing ring is in substantially radially opposite relationship to at least one of the sealing surfaces so that a fluid under pressure which bears in the cavity against the pressure surface urges at least one sealing surface outwardly, wherein the cavity has an outwardly leading fluid opening.

2. A sealing ring according to claim 1 characterized in that the cavity is a groove in an axial outside surface of the sealing ring.

3. A sealing ring according to claim 1 characterized in that the sealing ring is in the shape of a circular cylindrical tube.

4. A sealing system comprising a first component with a bore, a second component which is arranged in the bore, and a sealing ring according to claim 1 for sealing the gap between the first and the second component in relation to a fluid which at least at times is under pressure.

5. A sealing system according to claim 4 comprising a rolling bearing for carrying axial forces between the first and second components.

6. A sealing system according to claim 5 characterized in that the rolling bearing is in the form of a thrust groove-type ball bearing.

7. A sealing system according to claim 5 characterized in that the second component and the bore are of a circular-cylindrical configuration.

8. A sealing system according to claim 5 characterized in that the cavity has an opening for the fluid which is under pressure.

9. A sealing system according to claim 4 characterized in that the first component is a housing of a ball valve and the second component is the actuating spindle of a ball valve.

10. A sealing system according to claim 9 characterized in that the rolling bearing is so arranged that it can carry forces which act axially in relation to the actuating spindle and which are applied to the actuating spindle by way of the fluid flowing through the ball of the ball valve.

11. A sealing system according to claim 10 characterized in that a first bearing shell of the rolling bearing is supported on a surface which is remote from the flow passage provided in the ball and which is connected to the actuating spindle and a second bearing shell of the rolling bearing is supported on a surface which is towards the flow passage and which is connected to the housing.
